(19) United States
(12) Patent Application Publication
(10) Pub. No.: US 2018/0163636 A1
(43) Pub. Date: Jun. 14, 2018

(54) FUEL SUPPLY SYSTEM

(71) Applicant: ROLLS-ROYCE plc, London (GB)

(72) Inventor: Michael GRIFFITHS, Derby (GB)

(73) Assignee: ROLLS-ROYCE plc, London (GB)

(21) Appl. No.: 15/821,243

(22) Filed: Nov. 22, 2017

(30) Foreign Application Priority Data
Dec. 9, 2016 (GB) 1621009.8

(51) Int. Cl. F02C 9/26; F23R 3/34; F02C 7/232; F02C 7/22

(52) U.S. Cl. CPC F02C 9/263; F23R 3/346; F05D 2240/35; F02C 7/222; F05D 2220/32; F02C 7/232

(57) ABSTRACT

The fuel supply system includes mains pressurising and metering arrangement including a positive displacement ecology pump and an ecology valve piston chamber and a piston slidably movable in the chamber between de-prime and re-prime positions, the chamber forming a fuel sink to one side of the piston which increases in volume when the piston moves to de-prime position and reduces in volume when the piston moves to re-prime position. The ecology valve is fluidly connected to the ecology pump for pilot-only operation reverse direction operation of the ecology pump causes the piston to move to de-prime position removing mains fuel from injectors through a mains fuel distribution pipework and into the fuel sink, and for pilot and mains operation the forward direction operation of the ecology pump causes the piston to move to re-prime position refilling injectors with mains fuel from the fuel sink.

### FIELD OF THE INVENTION

The present invention relates to a fuel supply system for fuel injectors of a multi-stage combustor of a gas turbine engine.

### BACKGROUND

Multi-stage combustors are used particularly in lean burn fuel systems of gas turbine engines to reduce unwanted emissions while maintaining thermal efficiency and flame stability. For example, duplex fuel injectors have pilot and mains fuel manifolds feeding pilot and mains discharge orifices of the injectors. At low power conditions only the pilot stage is activated, while at higher power conditions both pilot and mains stages are activated. The fuel for the manifolds typically derives from a pumped and metered supply. A splitter valve can then be provided to selectively split the metered supply between the manifolds as required for a given staging.

A typical annular combustor has a circumferential arrangement of fuel injectors, each associated with respective pilot and mains feeds extending from the circumferentially extending pilot and mains manifolds. Each injector generally has a nozzle forming the discharge orifices which discharge fuel into the combustion chamber of the combustor, a feed arm for the transport of fuel to the nozzle, and a head at the outside of the combustor at which the pilot and mains feeds enter the feed arm. Within the injectors, a check valve, known as a flow scheduling valve (FSV), is typically associated with each feed in order to retain a primed manifold when de-staged and at shut-down. The FSVs also prevent fuel flow into the injector nozzle when the supply pressure is less than the cracking pressure (i.e. less than a given difference between manifold pressure and combustor gas pressure).

Multi-stage combustors may have further stages and/or manifolds. For example, the pilot manifold may be split into two manifolds for lean blow-out prevention during rapid engine decelerations.

During pilot-only operation, the splitter valve directs fuel for burner flow only through the pilot fuel circuit (i.e. pilot manifold and feeds). It is therefore conventional to control temperatures in the de-staged (i.e. mains) fuel circuit to prevent coking due to heat pick up from the hot engine casing. One known approach, for example, is to provide a separate recirculation manifold which is used to keep the fuel in the mains manifold cool when it is deselected. It does this by keeping the fuel in the mains manifold moving, although a cooling flow also has to be maintained in the recirculation manifold during mains operation to avoid coking.

FIG. 1 shows schematically a combustion staging system 130 for a gas turbine engine. A metered fuel flow arrives at the staging system at a pressure P_{fmu}. The staging system splits the fuel into two flows: one at a pressure Pₚ for first 131a and second 131b segments of a pilot manifold and the other at a pressure Pₘ for a mains manifold 132. Fuel injectors 133 of a combustor of the engine are split into two groups. The injectors of one group are connected to the first pilot manifold segment 131a, while the injectors of the other group are connected to the second pilot manifold segment 131b. The mains manifold feeds secondary discharge orifices of the fuel injectors. Pilot FSVs 139 and mains FSVs 140 at the injectors prevent fuel flow into the injectors when the pressure difference between the upstream manifold and the downstream combustion chamber is below the cracking point of the valve (i.e. at conditions where the mains is de-staged and at shut down). The FSVs also prevent combustion chamber gases entering the respective manifolds if the downstream pressure exceeds a manifold pressure. By varying the fuel split between the manifolds, staging control of the engine can be performed.

In more detail, the staging system 130 has a fuel flow splitting valve (FFSV) 134, which receives the metered fuel flow from a hydro-mechanical unit (HMU) at pressure P_{fmu}. A spool is slidable within the FFSV under the control of a servo-valve 135, the position of the spool determining the outgoing flow split between a pilot connection pipe 136 which delivers fuel to the pilot manifold segments 131a, b and a mains connection pipe 137 which delivers fuel to the mains manifold 132. The spool can be positioned so that the mains stage is deselected, with the entire metered flow going to the pilot stage. A position sensor 138 provides feedback on the position of the spool to an engine electronic controller (EEC), which in turn controls staging by control of the servo-valve.

Between the FFSV 134 and the second pilot manifold segment 131b, the pilot connection pipe 136 communicates with a lean blow out protection valve 150 which controls communication between the pilot connection pipe 136 and the second pilot manifold segment 131b. The lean blow out protection valve is spring biased towards an open position. A solenoid operated control valve 152 is operable to apply a control pressure to the valve member of the lean blow out protection valve to move it against the action of the spring so that the valve is biased to a closed position, restricting the communication between the pilot connection pipe 136 and the second pilot manifold segment 131b, when required. Accordingly, if there is only a pilot delivery of fuel to the engine and there is a concern that a lean blow out condition may occur, the lean blow out protection valve 150 can be closed by appropriate control of the solenoid operated control valve 152, with the result that fuel delivery to the second pilot manifold segment 131b is restricted, whilst that to the first pilot manifold segment 131a is increased. Adequate pilot delivery through the reduced number of injectors 133 fed by manifold segment 131a can therefore be assured, resulting in a reduced risk of a lean blow-out condition occurring.

The staging system 130 also has a recirculation line to provide the mains manifold 132 with a cooling flow of fuel when the mains manifold is deselected. The recirculation line has a delivery section including a delivery pipe 141 which receives the cooling flow from a fuel recirculating control valve (FRCV) 142, and a recirculation manifold 143 into which the delivery pipe feeds the cooling flow. The recirculation manifold has feeds which introduce the cooling flow from the recirculation manifold to the mains manifold via connections to the feeds from the mains manifold to the mains FSVs 140.

In addition, the recirculation line has a return section which collects the returning cooling flow from the mains manifold 132. The return section is formed by a portion of the mains connection pipe 137 and a branch pipe 144 from the mains connection pipe, the branch pipe extending to a recirculating flow return valve (RFRV) 145 from whence the cooling flow exits the recirculation line.

The cooling flow for the recirculation line is obtained from the HMU at a pressure HP_{f} via a cooling flow orifice (CFO) 146. On leaving the RFRV 145 via a pressure raising orifice (PRO) 147, the cooling flow is returned to the pumping unit for re-pressurisation by the HP pumping stage. A check valve 148 accommodates expansion of fuel trapped in the pilot and mains system during shutdown when the fuel expands due to combustor casing heat soak back. The check valve can be set to a pressure which prevents fuel boiling in the manifolds. The FRCV 142 and the RFRV 145 are operated under the control of the EEC. The HMU also supplies fuel at pressure HP_{f} for operation of the servo-valve 135, the RFRV 145, and the lean blow out protection valve 150.

When mains is staged in, a cooling flow is also directed through the recirculation manifold 143 to avoid coking therein. More particularly a small bypass flow is extracted from the HMU's metered fuel flow at pressure P_{fmu}. The bypass flow is sent via a flow washed filter 149 to a separate inlet of the FRCV 142, and thence through the delivery pipe 141 to the recirculation manifold 143. The bypass flow exits the recirculation manifold to rejoin the mains fuel flow at the injectors 133.

However, a problem with such a system is how to accommodate a mains FSV 140 failing to an open condition. In pilot-only operation, when cooling flow is passing through the recirculation manifold 143 and the mains manifold 132, such a failure can result in the cooling flow passing through the failed open FSV through one injector into the combustor, causing a hot streak which may lead to nozzle and turbine damage. In pilot and mains operation, such a failure can produce a drop in mains manifold pressure which causes other mains FSVs to close. A possible outcome is again that a high proportion of the total mains flow passes through the failed open FSV to one injector, causing a hot streak leading to nozzle and turbine damage

In principle, such failure modes can be detected by appropriate thermocouple arrangements, e.g. to detect hot streaks. However, temperature measurement devices of this type can themselves have reliability issues.

Further, the problem of mains FSV failure can be exacerbated by system arrangements used to prevent combustion chamber gas ingress through the fuel injectors 133 during pilot only operation. Whilst the impact of such gas ingress is generally non-hazardous, it can lead to hot gas-induced degradation of FSV seals. Degraded FSV sealing can in turn lead to dribbling of fuel into de-staged nozzles, resulting in component blockage due to coking. For example, the system may be modified to make orifice 147 variable under servo-valve control so that the deselected mains manifold pressure can be controlled to maintain it at a level below that required to crack open the mains FSVs 140 but above combustion chamber pressure in order to prevent ingestion of hot combustion chamber gases past the FSV seals. A disadvantage of such an arrangement is that in the event of a mains FSV 140 failing open, the system may try to maintain manifold pressure above combustion chamber gas pressure (which can be taken to be approximately the same as the measured engine parameter P30—the high pressure compressor outlet pressure), and thus may react by delivering more flow to the fuel injectors. This further increases the risk of reducing nozzle and turbine life.

### SUMMARY

It would be desirable to address these problems.

Accordingly, in a first aspect, the present invention provides a fuel supply system for fuel injectors of a multi-stage combustor of a gas turbine engine, the fuel supply system including:
a pilot pressurising and metering arrangement which receives a first portion of a low pressure fuel flow, and pressurises and controllably meters the first portion of the low pressure fuel flow into a high pressure metered pilot flow for injecting at pilot discharge orifices of the injectors;
a mains pressurising and metering arrangement including a positive displacement ecology pump, the mains pressurising and metering arrangement being configured to pressurise and controllably meter a second portion of the low pressure fuel flow into a high pressure metered mains flow for injecting at mains discharge orifices of the injectors, wherein the ecology pump is operable in a forward direction for pilot and mains operation in which there are pilot and mains supplies to the combustor from the injectors, the ratio of the metered pilot flow to the metered mains flow determining a staging control split of the pilot and mains flows, and wherein the ecology pump is operable in a reverse direction to provide a zero metered mains flow for pilot-only operation in which there is a pilot supply to the combustor from the injectors but no mains supply to the combustor;
pilot fuel distribution pipework distributing fuel from the pilot pressurising and metering arrangement to the pilot discharge orifices, and mains fuel distribution pipework distributing fuel from the mains pressurising and metering arrangement to the mains discharge orifices;
wherein the mains pressurising and metering arrangement further includes an ecology valve having a piston chamber and a piston slidably movable in the chamber between de-prime and re-prime positions, the chamber forming a fuel sink to one side of the piston which increases in volume when the piston moves to its de-prime position and reduces in volume when the piston moves to its re-prime position; and
wherein the ecology valve is fluidly connected to the ecology pump such that for pilot-only operation the reverse direction operation of the ecology pump causes the piston to move to its de-prime position thereby removing the mains fuel from the injectors through the mains fuel distribution pipework and into the fuel sink, and such that for pilot and mains operation the forward direction operation of the ecology pump causes the piston to move to its re-prime position thereby refilling the injectors with mains fuel from the fuel sink.

Thus in contrast to the system shown in FIG. 1, by de-priming the mains path in the injectors (removing mains fuel) when mains is de-staged and re-priming the mains path in the injectors (refilling with mains fuel) when mains is staged in, it becomes possible to perform staging control of a multi-stage combustor without a recirculating cooling flow to the mains manifold during pilot-only operation and without fuel scheduling valves in the mains fuel passages of the injectors. In particular, the ecology valve and ecology pump can be located in a relatively benign environment away from the injectors. Thus many of the problems indicated above can be avoided whilst enabling a simplified system (e.g. by removing mains FSVs and cooling recirculation architecture) with associated mass, cost and reliability benefits. Moreover, the use of the fuel sink can help to provide a fast and accurate re-priming capability.

The system also allows the injectors to have no pilot FSVs. These are not needed as the pilot supply flows continuously from the pilot fuel discharge orifices during normal operation and can be reverse purged at shut down to prevent any leakage into the injectors and combustor. The reverse purge can be achieved, for example, by providing a manifold drain valve under the action of combustion chamber gas pressure. Removal of the pilot FSVs is a further simplification with cost, mass and reliability benefits. It also eliminates any potentially hazardous failure modes associated with flow maldistribution and subsequent turbine torching which can occur as a result of a pilot FSV seizing in an open position.

In a second aspect, the present invention provides a gas turbine engine having a multi-stage combustor and the fuel supply system according to the first aspect for supplying fuel to and performing staging control in respect of pilot and mains fuel discharge orifices of fuel injectors of the combustor.

The gas turbine engine may further have a pumping unit to supply the low pressure fuel flow to the pilot and mains pressurising and metering arrangements of the fuel supply system. For example, the pumping unit may have a centrifugal pump to supply the low pressure fuel flow.

The fuel injectors may be without fuel scheduling valves in respect of their mains discharge orifices. Each fuel injector may, however, have a respective weight distribution valve for its mains discharge orifice. The weight distribution valves can help to eliminate gravitational head effects between the injectors.

Optional features of the invention will now be set out. These are applicable singly or in any combination with any aspect of the invention.

The pilot fuel distribution pipework may include a pilot fuel manifold distributing fuel from the pilot pressurising and metering arrangement to the pilot discharge orifices. The pilot manifold may include a segment restrictable by a lean blow out protection valve to decrease the proportion of the pilot fuel flow delivered to the injectors fed by the segment relative to the pilot fuel flow delivered to the remaining injectors of the combustor.

The mains pressurising and metering arrangement may typically be configured to fluidly isolate the mains fuel distribution pipework from the low pressure fuel flow during pilot-only operation. In this way fuel leakage to the mains fuel distribution pipework and subsequently into mains fuel passageways in and the mains discharge orifices of the injectors can be avoided, reducing the risk of injector coking during pilot only operation. For example, the ecology valve may have a drip tight seal which prevents leakage across the piston when the piston is in its de-prime position (during pilot only operation). Similarly, if the ecology valve has a parallel check valve, this may also have a drip tight seal which prevents leakage across the check valve during pilot only operation.

The pilot pressurising and metering arrangement may include: a high pressure pump, such as a positive displacement pump, for pressurising the first portion of the low pressure fuel flow (e.g. via a restriction downstream of the high pressure pump), and a metering valve (for example housed in an HMU) which receives and controllably meters the high pressure fuel flow from the high pressure pump. The high pressure pump can, for example, be shaft driven from the engine, or it can be electrically powered.

The fuel supply system may further have a controller to control the pilot and mains pressurising and metering arrangements. For example, the controller can be an element of an engine electronic controller (EEC).

The mains fuel distribution pipework may include a mains fuel manifold distributing fuel from the mains pressurising and metering arrangement to the mains discharge orifices. Moving the ecology valve piston to its de-prime position may also remove mains fuel from the mains fuel manifold (i.e. as well as removing fuel from mains passageways of the injectors), and moving the piston to its re-prime position may refill the mains fuel manifold with mains fuel (as well as refilling mains passageways of the injectors). Typically the more fuel is removed, the longer time is required for refilling. However, in general, enough fuel should be removed so as to effectively remove a risk of fuel egress into the injectors, causing coking.

Conveniently, the ecology pump may be electrically powered. This enables rapid pump accelerations, facilitating short de-priming and re-priming times.

The ecology pump may be positioned between the ecology valve and the mains fuel distribution pipework, the ecology pump pumping fuel from the mains fuel distribution pipework into the fuel sink prior to pilot-only operation to move the piston to its de-prime position, and the ecology pump pumping fuel from the fuel sink into the mains fuel distribution pipework prior to pilot and mains operation to move the piston to its re-prime position.

The ecology valve may have a position sensor which senses the position of the piston, the position sensor sending signals e.g. to a suitable controller such as an EEC, to vary the operation of the ecology pump when the piston reaches its de-prime and re-prime positions. For example, when the piston reaches its de-prime position, the signals can be used to reduce the reverse direction speed of the ecology pump in pilot-only operation. As another example, when the piston reaches its re-prime position, the signals can be used to initiate a mode of operation of the ecology pump to attain a given fuel split in pilot and mains operation, e.g. by varying the ecology pump speed to meter the required mains flow. More generally, however, the signals also allow refilling failure to be monitored, e.g. by an EEC.

The mains pressurising and metering arrangement may further include a relief valve in parallel to the ecology pump, the relief valve being configured such that, when the piston reaches its de-prime position, a rise in pressure in the fuel sink causes the relief valve to open whereby the ecology pump can continue to operate in the reverse direction (although typically at a reduced speed to minimise heat generation) pumping fuel in a circuit around the ecology pump and the relief valve, whilst maintaining the piston at its de-prime position.

The mains pressurising and metering arrangement may further include a low cracking pressure check valve in parallel to the ecology valve, the check valve being configured such that, when the piston reaches its re-prime position, a reduction in the pressure in the fuel sink causes the check valve to open whereby the second portion of the low pressure fuel flow is delivered through the check valve to the ecology pump for pressurisation thereby.

Conveniently, the ecology pump may also be used to meter the mains flow rate, e.g. by suitable control of the speed of the ecology pump. Preferably, in this case, the mains pressurising and metering arrangement further includes a flow sensing valve which senses the mains flow rate. Such a flow sensing valve facilitates closed loop control of the mains flow, e.g. by suitable control of the speed of the ecology pump. For example, a position sensor on the flow sensing valve, indicative of the level of mains metered flow rate can provide a signal to an EEC which in turn can send a control signal to a motor driving the ecology pump. The control signal sets the pump speed to deliver the required mains flow. The mains pressurising and metering arrangement may further include a restricted orifice bypass line in parallel to the flow sensing valve, the bypass line being configured such that, when the flow sensing valve is closed, the mains fuel removed from the injectors into the fuel sink during de-priming passes through the bypass line, and the mains fuel from the fuel sink which refills the injectors during re-priming passes through the bypass line. The restricted orifice can be configured such that, during pilot and mains operation, only a relatively small and compensatable portion of the mains flow bypasses the flow sensing valve.

### BRIEF DESCRIPTION OF THE DRAWINGS

Embodiments of the invention will now be described by way of example with reference to the accompanying drawings in which:

FIG. 1 shows schematically a combustion staging system for a gas turbine engine in pilot and mains operation mode;

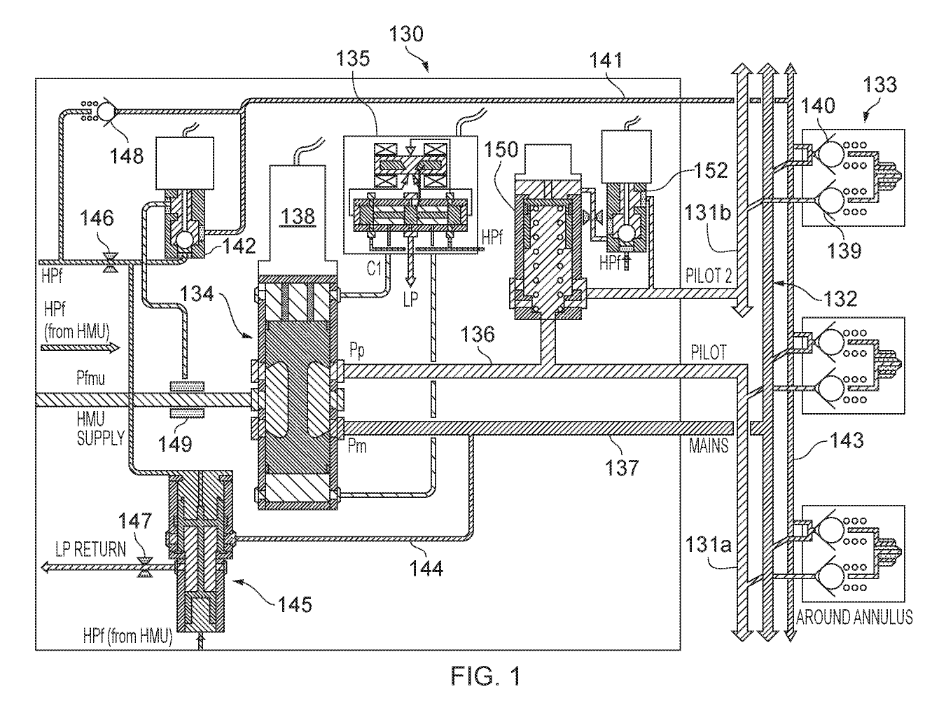

FIG. 2 shows a longitudinal cross-section through a ducted fan gas turbine engine;

FIG. 3 shows schematically a pump system and a fuel supply system for fuel injectors of a multi-stage combustor of the gas turbine engine with the fuel supply system providing pilot-only operation;

FIG. 4 shows schematically the pump system and the fuel supply system of FIG. 3 but with the fuel supply system providing pilot and mains operation; and

FIG. 5 shows schematically a variant of the pump system and the fuel supply system of FIGS. 3 and 4 with the fuel supply system providing pilot and mains operation.

### DETAILED DESCRIPTION AND FURTHER OPTIONAL FEATURES

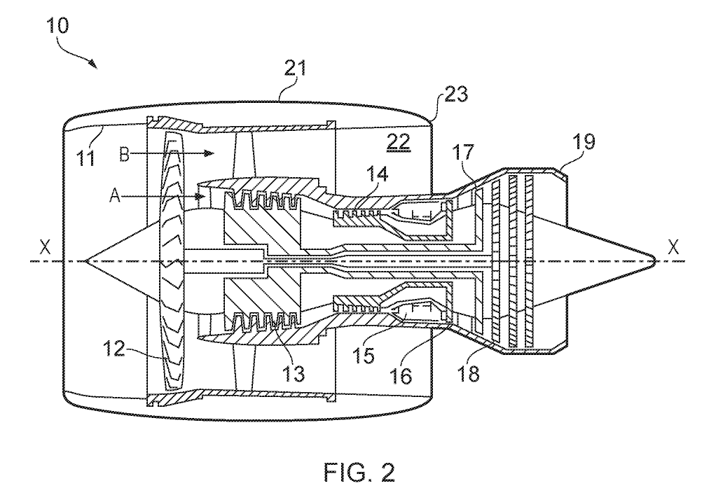

With reference to FIG. 2, a ducted fan gas turbine engine incorporating the invention is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

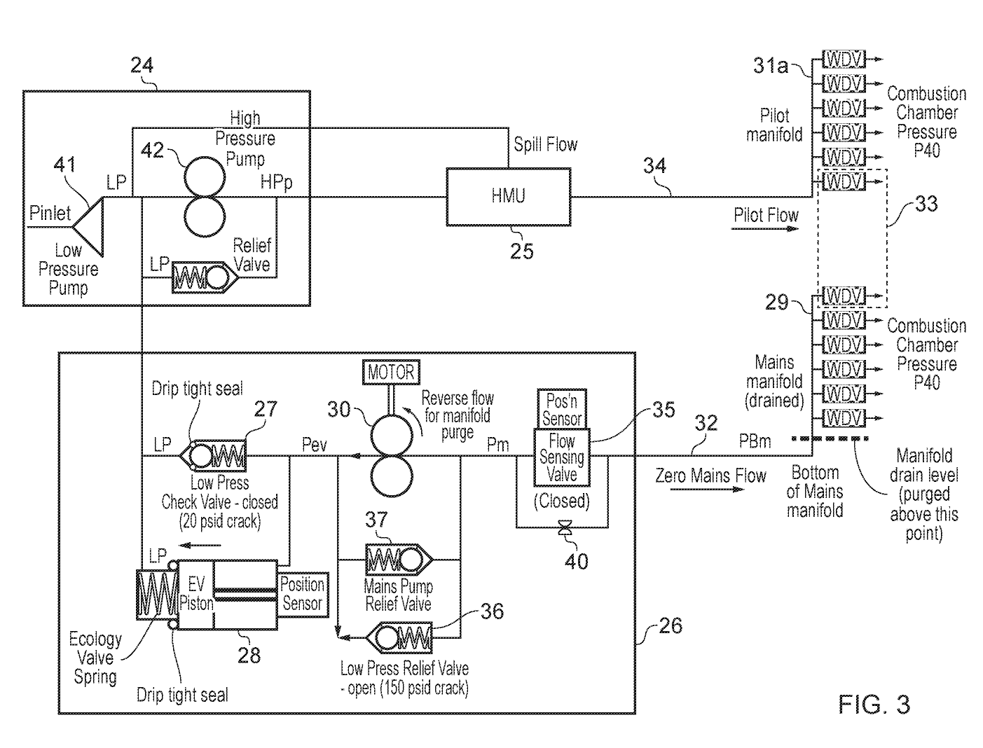

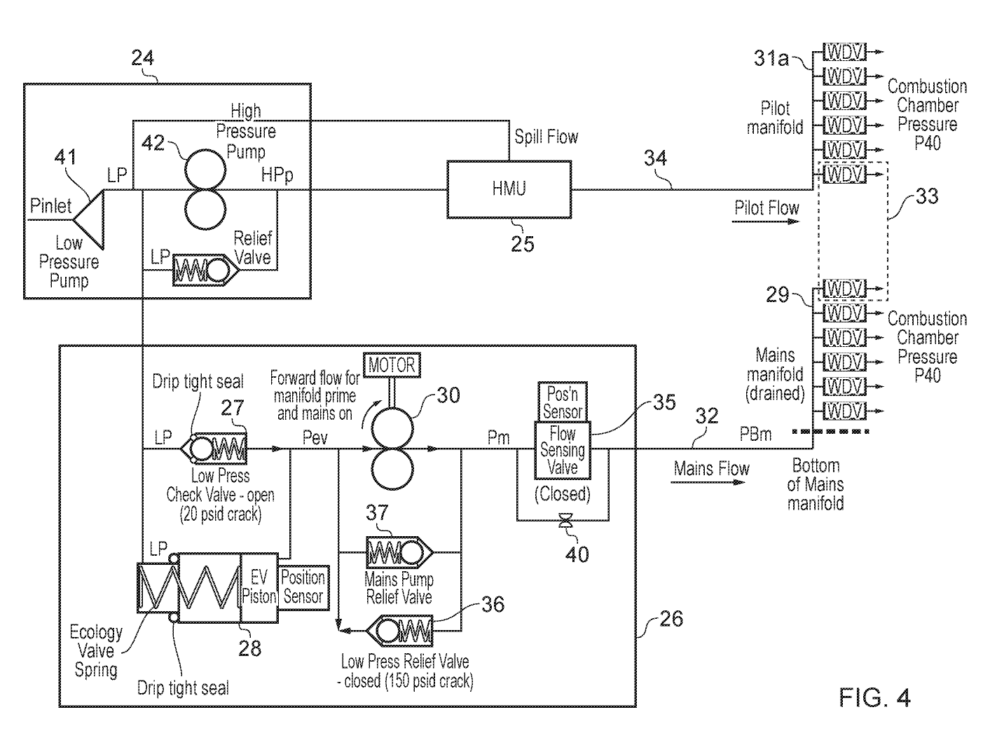

The combustion equipment 15 of the engine 10 includes a multi-stage combustor. FIGS. 3 and 4 show schematically a pump system 24 and a fuel supply system for fuel injectors of the multi-stage combustor. In FIG. 3 the fuel supply system is shown in pilot-only operation with mains supply off and the mains fuel passages of the injectors and a connecting mains manifold de-primed. In FIG. 4 the fuel supply system is shown in pilot and mains operation with the mains injector fuel passages and mains manifold re-primed and mains supply on.

The pump system 24 comprises typically a low pressure (LP) pumping stage 41 which draws fuel from a fuel tank of the aircraft and supplies a first portion of the fuel at boosted pressure to the inlet of a high pressure (HP) pumping stage 42. The LP stage may be a centrifugal impeller pump, while the HP pumping stage may comprise one or more positive displacement pumps, e.g. in the form of twin pinion gear pumps. The LP and HP stages can be connected to a common drive input, which is driven by the engine HP or IP shaft via an engine accessory gearbox.

The HP pumping stage 42 also forms the first part of a pilot pressurising and metering arrangement of the fuel supply system, the pilot pressurising and metering arrangement (described in more detail below) controllably metering the high pressure flow from the HP pumping stage to provide a high pressure metered pilot flow for injecting at pilot discharge orifices of the injectors 33. An offtake from the pump system 24 between the LP and HP pumping stages directs a second portion of the boosted pressure fuel from the LP pumping stage 41 into a separate and parallel mains pressurising and metering arrangement 26 of the fuel supply system, the mains pressurising and metering arrangement (also described in more detail below) providing a high pressure metered mains flow for injecting at mains discharge orifices of the injectors. In addition, the mains pressurising and metering arrangement provides the capability to de-prime/re-prime the mains fuel passages of the injectors and the mains manifold for fuel staging.

Focusing initially on the pilot pressurising and metering arrangement, this typically has a hydro-mechanical unit (HMU) 25 which receives the high pressure flow from the HP pumping stage 42. The HMU can comprise a fuel metering valve operable to control the rate at which the pilot fuel flow is sent to the combustor. The HMU further typically comprises: a pressure drop control arrangement (such as a spill valve and a pressure drop control valve) which is operable to maintain a substantially constant pressure drop across the metering valve, and a pressure raising and shut-off valve at the fuel exit of the HMU which ensures that a predetermined minimum pressure level is maintained upstream thereof for correct operation of any fuel pressure operated auxiliary devices (such as variable inlet guide vane or variable stator vane actuators) that receive fuel under pressure from the HMU. Further details of such an HMU are described in EP 2339147 A (hereby incorporated by reference).

The pilot flow is continuous. Total metered flow (pilot+mains) is metered in response to engine control parameters via an Engine Electronic Controller (EEC). Similarly, the pilot/mains flow split is set in accordance with the fuel staging laws, e.g. to reduce emissions.

The EEC commands the HMU fuel metering valve to supply pilot fuel to the combustor at a given flow rate. The metered pilot fuel leaves the HMU 25 into pilot fuel distribution pipework 34, and can be split by this pipework between first and second (or more) segments of a pilot manifold 31. A lean blow out protection valve actuated for example by a solenoid-operated control valve or similar device (both not shown) may be located between the pilot fuel distribution pipework and the second pilot manifold segment. Such a valve can be used to restrict the portion of total pilot flow passing to one of the pilot manifold segments such that the other segment receives a higher proportion of the flow to ensure that some of the injectors remain lit when there is a threat of lean blow out at certain operating conditions. Each fuel injector 33 of the combustor of the engine has a fuel spray nozzle (FSN) containing a pilot (primary) discharge orifice and a mains (secondary) discharge orifice. If the pilot manifold is split into two segments, the injectors are split into two groups. The pilot discharge orifices of the FSNs of the injectors of one group are connected to the first pilot manifold segment, while pilot discharge orifices of the FSNs of the injectors of the other group are connected to the second pilot manifold segment. The mains flow feeds the mains discharge orifices of the FSNs of both groups of the fuel injectors. The pilot and mains discharge orifices may have respective weight distribution valves (WDVs) to reduce gravitational head effects between the injectors.

Turning to the mains pressurising and metering arrangement 26, the second portion of boosted pressure fuel from the LP pumping stage is delivered to a low cracking pressure check valve 27 and to a spring chamber of an ecology valve 28. The ecology valve comprises a piston chamber and a piston slidably movable in the piston chamber between de-prime and re-prime positions. The piston chamber provides on one side the spring chamber, and on the other side a fuel sink which increases in volume when the piston moves to its de-prime position and reduces in volume when the piston moves to its re-prime position.

At steady state pilot and mains conditions, the flow rate to the spring chamber of the ecology valve 28 is zero as the fuel line is dead headed. The mains flow path is through the check valve 27 to an electrically driven ecology pump 30 (shown here as a gear pump but it can be a different type of positive displacement pump). The mains flow rate is varied by controlling the forward speed of the motor driven pump in response to a demand signal from the EEC. Downstream of the pump, the mains flow passes through a flow sensing valve 35 (or similar flow measurement device). This can be a single or two-stage device, e.g. as described in U.S. Pat. No. 5,795,998, hereby incorporated by reference. The flow sensing valve may comprise a piston moveable within a sleeve against a spring load, the piston opening/closing a flow port in the sleeve depending on the level of flow. Since the piston position is a measurement of mains flow rate, a position sensor is used to provide a feedback signal to the EEC. This facilitates closed loop control of mains flow. Open loop control, based on speed scheduling of the ecology pump and with no flow sensing device is also possible but is less accurate.

Downstream of the flow sensing valve 35, the total metered mains flow passes from the mains pressurising and metering arrangement 26, through mains fuel distribution pipework 32 and into a mains manifold 29. This manifold feeds mains flow to each injector 33, the flow passing through the mains fuel passages of the injectors and out through the mains discharge orifices to the combustion chamber (at pressure P40). As previously mentioned, WDVs at the injector heads can ensure an even distribution of flow, compensating for manifold head effects.

In pilot-only operation (FIG. 3), the HMU 25 meters pilot flow to the pilot discharge orifices. Mains flow is de-selected by powering the electrically driven ecology pump 30 in a reverse sense direction, thereby stopping further flow to the mains discharge orifices. Initially, the pump performs an ecology function, draining a fixed volume of fuel from the mains fuel passages of the injectors 33, and typically also from the mains manifold 29, into the fuel sink (non-spring chamber) of the ecology valve 28 at pressure Pev. As the pump draws fuel, Pev rises and is set by the ecology valve spring and piston diameter to be above the delivery pressure (LP) of the low pressure pumping stage in the pump system 24 (for example, Pev−LP 410 kPa (60 psi)). The pressure level is sufficient to cause the low pressure check valve 27 to close (for example, closure can occur when LP−Pev<140 kPa (20 psi) approx.). A drip tight seal in the check valve prevents fuel flow, or the ingress of any hot combustion gases (at P40) back into the low pressure fuel system. At the same time, pressure Pev is insufficient to crack open a low cracking pressure relief valve 36 which is in parallel to the ecology pump (for example, the relief valve may crack at Pev−Pm≈1.0 MPa (150 psi), where Pm is the line pressure on the mains fuel distribution pipework side of the ecology pump).

When the low pressure check valve 27 is closed, the flow from the reverse-direction flowing ecology pump 30 displaces the piston of the ecology valve 28 to the left, as illustrated in FIG. 3. As the piston moves, it draws the fixed volume of mains fuel into the valve's fuel sink so that, (i) the mains fuel passages of the injectors 33 are fully emptied, and (ii) the mains manifold 29 is sufficiently emptied to avoid subsequent ingress of mains fuel into the injectors should the remaining fuel in the mains manifold/mains fuel distribution pipework expand under temperature during pilots-only operation or be displaced during aircraft maneuvers. Draining the injectors of mains fuel protects their narrow internal mains passages during pilot-only operation. With no residual mains fuel present in the injectors, it cannot breakdown under temperature (coke) which would cause blockage of the passages and increase injector-to-injector maldistribution with an overall reduction in injector life. Some external cooling (for example, air cooling) may be required to prevent coking in the de-staged mains manifold).

When the ecology valve 28 reaches its left hand stop (de-prime position), the ecology pump 30 is dead-headed and Pev rises to crack open the low cracking pressure relief valve 36 (i.e. Pev−Pm>1.0 MPa (150 psi)). At the same time, the low cracking pressure check valve 27 is held closed since Pev>LP. In this state, the mains pressurising and metering arrangement 26 allows any flow displaced by the ecology pump to recirculate via the low cracking pressure relief valve 36. The speed of the pump can be reduced to reduce any heat input into the fuel, as it only has to provide sufficient pressure to hold the ecology valve on its left hand stop to maintain the mains passages of the injectors 33 and the mains manifold 29 de-primed.

A position sensor on the ecology valve 28 can provide an indication of the valve reaching its stop, and when this is confirmed the speed of the ecology pump 30 can be reduced. The flow left recirculating around the pump causes no net change in the volume of fuel left in the mains fuel distribution pipework 32, so the mains passages of the injectors 33 and the mains manifold 29 remain de-primed throughout the duration of pilot-only operation.

The piston of the ecology valve 28 sits against a face seal to achieve a drip tight seal. In combination with the drip tight seal of the low pressure check valve 27, this achieves isolation of the de-primed mains passages/mains manifold from the pump system 24. The seals prevent ingress of LP fuel into the de-primed mains passages/mains manifold when LP>P40, and also prevent ingress of hot combustion gas (at P40) back into the pump system at conditions where P40>LP.

When mains flow is required for pilot and mains operation, the ecology pump 30 is powered in a forward sense to drive the piston of the ecology valve 28 to the right, as illustrated FIG. 4. This displaces fuel from the ecology valve fuel sink to re-prime the mains injector passages and mains manifold.

Advantageously, the electrically driven ecology pump 30 can be accelerated rapidly to provide rapid re-prime capability. When the pump begins to rotate in the forward sense, Pev falls (e.g. to Pev−LP≈410 kPa (60 psi)) as determined by the ecology valve piston diameter and spring. This causes the low pressure relief valve 36 (having e.g. a cracking differential≈1.0 MPa (150 psi)) to close, and at the same time the low pressure check valve 27 and a mains pump relief valve 37 (also in parallel to the ecology pump) remain closed. As the ecology pump draws flow from the fuel sink of the ecology valve, the valve piston moves to the right so that the fixed volume of fuel is displaced via the pump back into the mains fuel distribution pipework/manifold/injector passages, fully re-priming these volumes prior to mains flow being demanded. The WDVs limit any pre-leakage to the mains discharge orifices.

The ecology valve position sensor provides indication of the valve 28 reaching its right hand stop (i.e. its re-prime position corresponding to the mains manifold/injector passages being fully re-primed). On reaching the stop, with the ecology pump 30 still rotating in a forward sense, Pev falls towards vapour pressure (<LP) until the low pressure check valve 27 cracks open (e.g. when LP−Pev≈140 kPa (20 psi)) to feed the pump from the LP pumping stage 41 of the pump system 24. At this point, the speed of the ecology pump can be varied under closed loop control to meter the correct mains flow to the fully primed mains passages of the injectors 33.

The downstream flow sensing valve 35 provides a flow measurement signal to the EEC, which responds to engine control laws to set the ecology pump speed for the required flow level. Pilot flow is metered by the HMU 25 so that the two flow streams are controlled independently. This ensures that there are no significant dips and spikes in the pilot flow at the mains staging points or when mains flow is modulated.

A restricted orifice bypass line 40 can be provided in parallel to the flow sensing valve 35. When the flow sensing valve is closed, the bypass line allows the mains fuel removed from the injectors/mains manifold into the fuel sink to pass around the closed valve and similarly allows the mains fuel from the fuel sink which refills the injectors/mains manifold to pass around the closed valve. The restricted orifice can be configured such that, during pilot and mains operation, only a relatively small and compensatable portion of the mains flow bypasses the flow sensing valve.

The ecology valve 28 does not require a drip tight seal when the piston is on its right hand stop as any leakage from LP to Pev merely results in a slightly lower flow through the low pressure check valve 27, with no overall effect on performance. The mains pump relief valve 37 prevents any over-pressurisation of the ecology pump 30 specifically and the mains pressurising and metering arrangement 26 generally in the event of a blockage occurring downstream of the pump.

The fixed volume of fuel displaced during de-priming and re-priming is determined by the ecology valve diameter and travel, and can be set to be:
(i) Sufficiently large to ensure that a full de-prime of the mains passages of the injectors 33 and mains manifold 29 is achieved for pilot-only operation;
(ii) Sufficiently large so that in pilot-only operation, any expansion of the residual fuel in the mains fuel distribution pipework 32 at high temperatures does not result in fuel ingress into the injectors;
(iii) Sufficiently large so that in pilot-only operation, any displacement of the residual fuel in the mains fuel distribution pipework 32 during aircraft maneuvers does not result in fuel ingress into the injectors; and
(iv) As low as possible to minimise re-prime time, so that the engine can achieve acceleration performance requirements.

Advantageously, the fuel supply system:
1. Permits removal of FSVs and hence mitigates associated risks (i.e. mal-scheduling due to failed open FSV; reduces injector-to-injector fuel maldistribution due to component and frictional variation; avoids lifing issues such as FSV seal wear/degradation leading to fuel dribbling and consequent nozzle coking); provides combustion efficiency benefits at low mains flow conditions.
2. Avoids complex mains manifold cooling flow recirculation architectures.
3. Avoids ingress of hot combustion gases (P40) into the fuel system. The ecology valve 28 and low cracking pressure check valve 27 isolate the reverse flowing ecology pump 30 from the LP system when the main manifold 29 is de-primed.
4. Provides cost and mass benefits associated with 1 & 2 above.
5. Provides via the ecology pump 30 and the ecology valve 28 an accurate means of controlling the volume of fluid displaced during de-priming/re-priming. In particular, excessive de-priming can be avoided, so that the re-prime time can be minimised. There is also no risk of drawing hot P40 gases into the LP system. Similarly, the mains manifolds and mains passages of the injectors are not significantly over-filled during re-priming so there is only a low risk of pre-fuelling mains combustor zones before mains is selected.
6. Provides via the electric drive to the ecology pump 30 a rapid re-prime capability, making it practical to de-prime/re-prime a large fixed volume (e.g. that empties the entire mains manifold 29) whilst ensuring that the engine can still meet its acceleration performance requirements, particularly at take-off and go-around scenarios.
7. Allows use of the ecology pump as a dual purpose device, providing a means of metering the mains flow and also, a means of priming/de-priming when the mains is staged in/out.
8. Independently controls the pilot and mains flow streams to reduce cross-talk so that significant dips or spikes in the pilot flow can be avoided at the mains staging points or when mains flow is modulated. Similarly, significant dips or spikes in the mains flow can be avoided when pilot flow is modulated.
9. Provides redundancy capability if the ecology pump 30 or its electric drive fails. In particular, if the pilot flow control does not have an electrical pump drive, control can be maintained via the shaft driven pump system 24 and the HMU 25.
10. Allows the system to be extended to include circumferential staging, i.e. if more than one mains stage is required, the mains pressurising and metering arrangement 26 can be replicated for the additional stages.
11. Reduces heat input into the fuel when mains is selected by avoiding a spill flow recirculating around the variable speed ecology pump 30. This in turn allows the engine oil system to pass more heat to the fuel, thereby allowing a reduction the size of other oil coolers on the engine.
12. Provides independent pilot and mains metering systems which can accurately set the total burner flow and pilot/mains flow split with minimal sensitivity to any of the downstream restrictions e.g. blocked burner discharge nozzles, WDVs etc.

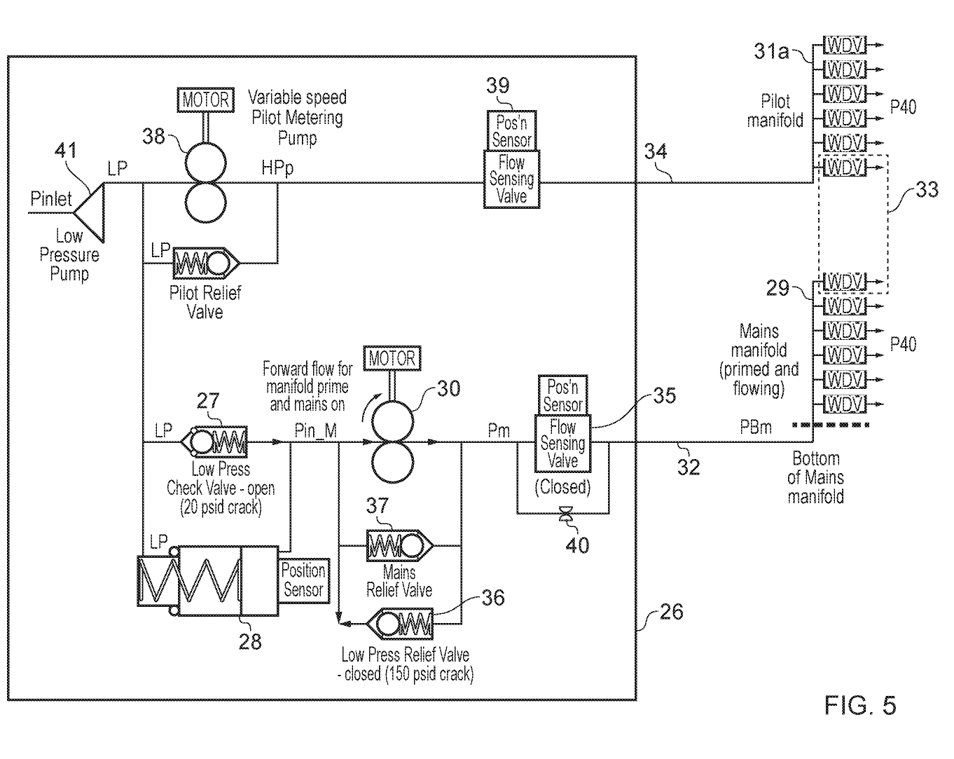

The system can be re-configured to replace the shaft driven HP pumping stage of the pump system 24 with a variable speed, motor driven pump used for pressuring and metering the pilot flow. This configuration is illustrated in FIG. 5 as a variant of the pump system and a fuel supply system of FIGS. 3 and 4 in pilot and mains operation. The mains pressurising and metering arrangement 26 remains unchanged, taking flow from a conventional shaft driven LP pumping stage. However, in the variant HP pumping stage, the shaft driven HP pumping stage and the HMU for pilot flow control are replaced by a motor driven, variable speed pilot pump 38 (shown here as a gear pump but it could be a different type of pump such as a piston pump) and a pilot flow sensing device 39 located downstream of the pilot pump. Closed loop control of the pilot flow can be achieved via the EEC, using a flow measurement signal from the pilot flow sensing device 39, comparing it to the demanded flow and then adjusting the motor/pump speed to deliver the required flow pilot flow.

A benefit of this variant is the avoidance of a spill system associated with a shaft driven pump/metering control arrangement. The electrically driven pilot pump 38 delivers only the amount of flow required by the pilot fuel passages of the injectors 33, so there is no excess spill flow recirculating around the pump, adding heat to the fuel. This helps to further reduce the size of any additional oil coolers on the engine, as more heat that is generated in the oil system can be passed into the fuel system.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

What is claimed is:

1. A fuel supply system for fuel injectors of a multi-stage combustor of a gas turbine engine, the fuel supply system including:
a pilot pressurising and metering arrangement which receives a first portion of a low pressure fuel flow, and pressurises and controllably meters the first portion of the low pressure fuel flow into a high pressure metered pilot flow for injecting at pilot discharge orifices of the injectors;
a mains pressurising and metering arrangement including a positive displacement ecology pump, the mains pressurising and metering arrangement being configured to pressurise and controllably meter a second portion of the low pressure fuel flow into a high pressure metered mains flow for injecting at mains discharge orifices of the injectors, wherein the ecology pump is operable in a forward direction for pilot and mains operation in which there are pilot and mains supplies to the combustor from the injectors, the ratio of the metered pilot flow to the metered mains flow determining a staging control split of the pilot and mains flows, and wherein the ecology pump is operable in a reverse direction to provide a zero metered mains flow for pilot-only operation in which there is a pilot supply to the combustor from the injectors but no mains supply to the combustor;
pilot fuel distribution pipework distributing fuel from the pilot pressurising and metering arrangement to the pilot discharge orifices, and mains fuel distribution pipework distributing fuel from the mains pressurising and metering arrangement to the mains discharge orifices;
wherein the mains pressurising and metering arrangement further includes an ecology valve having a piston chamber and a piston slidably movable in the chamber between de-prime and re-prime positions, the chamber forming a fuel sink to one side of the piston which increases in volume when the piston moves to its de-prime position and reduces in volume when the piston moves to its re-prime position; and
wherein the ecology valve is fluidly connected to the ecology pump such that for pilot-only operation the reverse direction operation of the ecology pump causes the piston to move to its de-prime position thereby removing the mains fuel from the injectors through the mains fuel distribution pipework and into the fuel sink, and such that for pilot and mains operation the forward direction operation of the ecology pump causes the piston to move to its re-prime position thereby refilling the injectors with mains fuel from the fuel sink.

2. A fuel supply system according to claim 1, wherein the mains pressurising and metering arrangement further includes a flow sensing valve which senses the mains flow rate.

3. A fuel system according to claim 2, wherein the mains pressurising and metering arrangement further includes a restricted orifice bypass line in parallel to the flow sensing valve, the bypass line being configured such that, when the flow sensing valve is closed, the mains fuel removed from the injectors into the fuel sink during de-priming passes through the bypass line, and the mains fuel from the fuel sink which refills the injectors during re-priming passes through the bypass line.

4. A fuel supply system according to claim 1, wherein the mains pressurising and metering arrangement is configured to fluidly isolate the mains fuel distribution pipework from the low pressure fuel flow during pilot-only operation.

5. A fuel supply system according to claim 1, wherein the mains fuel distribution pipework includes a mains fuel manifold distributing fuel from the mains pressurising and metering arrangement to the mains discharge orifices.

6. A fuel supply system according to claim 5, wherein moving the piston of the ecology valve to its de-prime position also removes mains fuel from the mains fuel manifold, and moving the piston to its re-prime position refills the mains fuel manifold with mains fuel.

7. A fuel system according to claim 1, wherein the ecology pump is electrically powered.

8. A fuel system according to claim 1, wherein the ecology pump is positioned between the ecology valve and the mains fuel distribution pipework, the ecology pump pumping fuel from the mains fuel distribution pipework into the fuel sink to move the piston to its de-prime position prior to pilot only operation, and the ecology pump pumping fuel from the fuel sink into the mains fuel distribution pipework to move the piston to its re-prime position prior to pilot and mains operation.

9. A fuel system according to claim 1, wherein the ecology valve has a position sensor which senses the position of the piston, the position sensor sending signals to vary the operation of the ecology pump when the piston reaches its de-prime and re-prime positions.

10. A fuel system according to claim 1, wherein the mains pressurising and metering arrangement further includes a relief valve in parallel to the ecology pump, the relief valve being configured such that, when the piston reaches its de-prime position, a rise in pressure in the fuel sink causes the relief valve to open whereby the ecology pump can continue to operate in the reverse direction pumping fuel in a circuit around the ecology pump and the relief valve, whilst maintaining the piston at its de-prime position.

11. A fuel system according to claim 1, wherein the mains pressurising and metering arrangement further includes a low cracking pressure check valve in parallel to the ecology valve, the check valve being configured such that, when the piston reaches its re-prime position, a reduction in the pressure in the fuel sink causes the check valve to open whereby the second portion of the low pressure fuel flow is delivered through the check valve to the ecology pump for pressurisation thereby.

12. A gas turbine engine having a multi-stage combustor and the fuel supply system according to claim 1 for supplying fuel to and performing staging control in respect of pilot and mains fuel discharge orifices of fuel injectors of the combustor.
